(19) United States
(12) Patent Application Publication
(10) Pub. No.: US 2008/0230740 A1
(43) Pub. Date: Sep. 25, 2008

(54) Nontoxic Watery Solution Against Freezing and Corrosion and the Regenerator For the Utilized Antifreeze

(76) Inventor: Vladisav Milovanovic, Belgrade (YU)

Correspondence Address: David Burleson;Zollinger + Burleson, P O Box 2368, Canton, OH, 44720, US

(21) Appl. No.: 10/579,109

(22) PCT Filed: Oct. 28, 2004
(86) PCT No.: PCT/YU04/00026

§ 371 Date: May 13, 2006

(30) Foreign Application Priority Data
Nov. 13, 2003 (YU) P.908/03

(51) Int. Cl. C09K 3/18

(52) U.S. Cl. 252/70

(57) ABSTRACT

It is a nontoxic liquid for cooling of all types of engines, anticorrosive protection, boiling point over 130° C., freezing point over −40° C., it's not harmful to people, animals and plants. The inhibitors and additives make the basic protection against freezing and corrosion in engine. The additives are compatible with the additives for cooling systems recommended by some vehicle and motors producers, like Chrysler, General Motors, Ford, so this coolant meets and exceeds their demands. The basic substance and additives are given in description patent The Formulation of Nontoxic liquid Watery Solution Against Freezing and Corrosion (table “A”) as well as the chemical formulas. When the inhibitor from the patent The Formulation of Watery Solution of Inhibitor Against Corrosion for Utilized Antifreeze is used into the basic substance glycerol-water), the inhibitor is added in 10-15% of weight part. Such a product is applicable immediately.

### FIELD OF THE ART

The present invention is related to field of cooling an internal combustion engines passenger end truck vehicles), and also cooling of other cooling and heating systems where beat exchanger is used. Precisely, this invention is related to field of fluids—liquids for cooling the operating engine, i.e., to the anti-freezing and anticorrosive agent composition (antifreeze is the word originating from English language and as such it is adopted in our language, and literally it means anti ice, anti freezing) and to the composition of antifreeze regeneration agent, primarily glycerin-based, and which are thereat absolutely nontoxic, and which comprise variety of other components, depending on application in particular weather conditions, i.e., conditions of application.

According to international patent classification (MKP/IPC) inventions belong to class F 01 P 3/00, class B 60 K 11/02, by which the cooling of machines (engines) or other cooling and heating systems are generally defined, i.e., cooling by fluid liquids, which are added to stop the corrosion. Beside the said class, inventions belong to class C 09 K 005/00, by which devices and apparatus in vehicles are defined such as to facilitate cooling of operative units with cooling liquid.

### TECHNICAL PROBLEM

The technical problem which is solved by inventions is how to obtain composition—anti-freezing agent in open and closed cooling systems, to obtain nontoxic liquid (fluid) for heat exchange according to the invention, and at the same time to obtain anticorrosive protection in cooling system for all metals, especially for aluminum engines or parts of the engine, i.e., how to obtain agent composition that will be used for regeneration and modification of anti-freezing and anti-corrosive agent.

### STATE OF THE ART

There are known cooling fluids which are used in the cooling systems of internal combustion engines, in open and closed cooling systems, which do tot freeze at temperatures from −30° C. to −40° C. Most of these fluids are in market under the name antifreeze, and among domestic manufacturers the major are: Kotrman, NIS-Naftagas, Petrohemija-Pan\check{c}evo, in Bosnia and Herzegovinia—Optima Modri\check{c}a, etc. There are known great world manufacturer among which major are BASF from Germany, Preston from SAD, and many other.

Mainly, the compositions are specifically formulated with ethylene glycol or propylene glycol, or with derivates thereof and include additives which inhibit and reduce corrosion of the cooling system. Very important is to develop specific cooling agent formulations, because with appearance of engines with higher performances, especially heavy-duty diesel engines, there are growing numbers of these engines components which are produced from variety of materials to reduce, weight and enhance efficacy. Therefore, specific additives are selected so to provide special advantages, such as providing protection for one or more selected materials. However, these additives are often selected in such a way that their beneficial properties are mutually supplemented. Despite formulating specificity of these cooling agent compositions, advantages that are connected to many additives may be disturbed, because many drivers pour hard water in the cooling system. Hard water may be added either ah initial filling of the cooling system or during the service, since drivers themselves, but also workers in relevant services add ordinary water in the cooling system (i.e., they change water that have been lost by evaporation and the like).

However, in many parts of the world there is no available suitable water for use in the cooling system Hard water contains certain number of minerals, mostly calcium, magnesium and iron salts. These minerals may contribute to loss of efficacy and to reduce lifetime of cooling agent composition. The loss may be especially adverse for heavy-duty diesel engines that may pass away over 20 000 kilometers per month Non-effective cooling agent composition may reduce engine lifetime, clog intel passages in the cooling system, contribute to cylinder liner corrosion and clog water pump, where all that have as a result an expensive engine repair.

Surely, the tendency of reducing noxious gasses emission has as a result some progress in engine emission technology, and that progress may induce change of usual ethylene glycol and/or propylene glycol bases which have been for almost one century main carrier for engine antifreeze formulations. New engine components, especially devices for exhaust gasses recirculation (EGR), produce much bigger thermal stress to engine cooling agent. Ethylene glycol and propylene glycol oxidation may be drastically accelerated, which results in cooling agent that becomes improper for continuous usage, even in such short time intervals as several months. Therefore, manufacture is moving toward formation engine cooling agents which operate in longer time intervals, i.e., toward formation agents by which it will be possible to regenerate and/or optionally to modify wasted cooling agent (antifreeze).

Because of what is stated but also because of number of other reasons, there is continuous need for improvement of cooling agent compositions and for improved processes of corrosion reduction which are connected with cooling agent compositions. This invention represents such improvement and it provides great number of different advantages.

There are relatively a great number of patent applications, i.e., approved patents which describe antifreeze, i.e., cooling agent Generally, according to herein applied invention, difference is in that their basic bases are mostly some other chemicals and that they use less additives, and in different ration, where for most of them it could be said that they don't have anti-corrosive effect and almost all are toxic.
Patent application FP 1010740 A1 discloses solution which comprises glycerol as a basis, but which comprises only 4 additives;
Invention from patent application published under number WO 03/040254 A1, as basic basis has alcohol, mid parts of patent application which are related to glycerin base also have lesser number of additives;
Inventions from patent DE 1125407, 569771, 1 125 407 are made from mixture of propylene glycol (i.e., glycol—but it is not said which) and glycerol therefore anti-corrosive protection is not sufficient;
In patent application published under number WO 02/08354 A1 antifreeze is made with basic base of monoethylene glycol of about 69% with small amount of glycerol, and therefore there have not been accomplished sufficient anti-corrosive protection;
In patent DE 10163337, antifreeze is mule with basic base of monoethylene glycol of about 69% with small amount of glycerol, and therefore there have not been accomplished sufficient anti-corrosive protection;
In patent number 2540 251, antifreeze is made with basic base of propylene glycol;
In patent application 048 430 A1, antifreeze is made with monopropylene glycol and ethylene glycol;
In patent number U.S. Pat. No. 4,000,79 A, antifreeze is made with glycol and other anti-corrosive protection agents;
In patent number US 455 248 A,-antifreeze is made with glycol;
In patent application 4 404 113 A, antifreeze is made with basic base of 94% monoethylene glycol, and alcohol glycerol have been used as an inhibitor, with other additives;
In patent number US 489 391, antifreeze is made by using glycol, i.e., ethylene glycol to 94,74%, but there have not been used enough additives;
In patent application U.S. Pat. No. 5,387,360 A, antifreeze is made with basic base of ethylene glycol to 92,489%;
In patent application US 2003/198847 A1, inhibitor protection is made for more types of basic crude materials which are used for antifreeze preparation, and among them glycerol.

Disadvantage of all mentioned, but also many other solutions, is that they are toxic, their lifetime is limited to the most two years, they have not sufficient inhibitory protection, they weaken alkali stocks, their pH value is small—about 6,2-7,2 (it must be between 9,5-11,5 according to ASTM standard—USA standard). Inventions applied herein meet ASTM standards.

### Presentation of Essence of the Invention

This invention is related to new anti anti-freezing (and anti-boiling) agent composition with non-toxic basis in water solution in concentration to 96%, which can be used immediately. This antifreeze may be used concentrated or diluted with distilled water. It is non-toxic.

Here is also presented the composition of anti-corrosive inhibitor in water solution for wasted antifreeze, which beside the composition of antifreeze alone makes invention conception unique, in sense of its using on the one hand for antifreeze production and on the other for regeneration and modification of that antifreeze, when antifreeze is wasted.

Applicant noted that detailed descriptions of both inventions are given below, but their specific compositions will be dependent only of application conditions (type of the vehicle, i.e., other agent, climatic conditions and other). In that sense given compositions are not limiting.

First, anti-freeze and anti-corrosive agent composition (antifreeze) will be represented. This composition base m distilled (softened) water, non-toxic base (glycerol), and suitable inhibitors. By mixing these ingredients, anti-freezing and anti-corrosive agent for engines is obtained, which is ecologically correct, biodegradable, non-toxic and not harmful for natural resources, does not pollute soil and water, not toxic for humans, fishes, animals and pets, and thereat it successfully protects engine (protects system against freezing and corrosion, against forming plaque and foam in the system, and rises boiling point above 120° C.).

For composition of anti-freeze and anti-corrosive agent, following additives are used as inhibitors:

A) Additives as inhibitors.
1. Glycerol
   chemical formula C₃H₈O₃
   quality min. 98,0% (99,5%)
2. Water—soften or distilled
3. Benzotriazole—effective inhibitor against corrosion of metals in neutral solutions
4. Three-ethanol-amine (HOCH₂CH₂)₃N—an inhibitor against corrosion of iron and steel in watery solution)
5. Sodium-tetraborate
   chemical formula Na₂B₄O₇
   an inhibitor for several metals, aluminum and their alloys
6. Sodium-nitrate
   chemical formula NaNO₃
   protects several metals
7. Sodium-nitrite
   chemical formula NaNO₂
   necessary concentration depends on corrosion conditions and water content in formulation
8. Sodium-sul
   chemical formula (without water NaSO₃) or (naSO₃)₇H₂O
   in this formulation, it's a good inhibitor for magnesium aluminum or their alloys in alkali environment or in watery solution of glycerol
9. Potassium-sulfide
   chemical formula K₂SO₄
   min. 99% quality
   solution-easy soluble in water
   in this formulation, an inhibitor of aluminum, magnesium and their alloys
10. Sodium-chromate
   chemical formula in acids HNO₃, H₃PO₄ and H₂SO₄
   corrosion inhibitor of steel, cast iron, aluminum, cooper, zink and messing in watery solution of this formulation
11. Sodium-benzoate
   chemical formula C₆H₅SO₆a or (C₇H₅O₂Na)
   corrosion inhibitor of steel in water solutions and well preserved pH value and alkalis
12. Calcium-cyanamide
   in this formulation, corrosion inhibitor of steel in watery solutions and solutions of salts
13. Sodium-hydroxide
   suitable for aluminum protection as well as for the preserving of alkali reserve and pH value between 9-11
14. Polymark-polycaroxilate BASF, soluble in watery and alcohol solutions. In this invention is eked as SOKALON® CP-12S or CP-10. In this formulation well applicable is ABC COBLEX's polycarboxilate, too.
15. Sodium-metaborate
   chemical formula (calculated on B2O3)+2+3+4 with application in concentration 0,5-5 mass parts
   an inhibitor for metals in formulation of nontoxic antifreeze based on glycerol

Process for obtaining antifreeze is conducted through several phases. Firsts distilled water preparation is performed (softened to I degree), or totally distilled and free from all minerals and contamination. Mixing is performed with polyvalent alcohol (glycerol) at temperatures of 80-90° C., with continuous agitating until homogenization completed. Basic base—crude material rations, may be different dependent on what is desired to be designed. Main crude material may be 66:34, 70:30, 80:20, and different ratios are possible. In said ratios it is necessary to left space for inhibitor (modifier, emulsifier) (whose composition will be presented below in this application) with its participation in quantitative content with 10-20%. After that, heating is continued with the same temperature and agitating until homogenization (unification) of the product completed. Against foaming, silicate oil is added in small concentrations of 0,004-0,009%. Additionally, high quality and also non-toxic dye is added, that is used for nutrition or cosmetics. Final product is light green or light blue liquid. Dye is added to fluid to indicate is there any liquid in the system, and thus obtained liquid is white and clear.

In other words, the performing of the production process is the following: the substances-additives in group A is mixing, then, there is a mixing of additives from group B, and finally, the mixing of additives from group C. After that, on the same sequence as above, there is mixing of groups, one by one, on the temperature of 80° C., using a mixer with small numbers of revolutions, about 100-200 revolutions per minute.

The mixed additives are mixing into the basic substance, according to tables and sequence, after the preparation of additives. The relations is the following: for minus temperature of −25° C., the additives from table “A” are used with 38% of basic substance (glycerol), for temperature of −35° C., the formulation from table “A”/B is mixing with 48% of basic substance, for temperature of −55° C. the formulation from table “A”/C is mixing with the 60% of basic substance, and for the minus temperature over 65° C. there is a mixing of formulation from table “A”/D with the 88% of basic substance All these combination can maintain the temperature from 110° C. tilt 160° C. in plus.

Thus obtained antifreeze is non-toxic, biodegradable and it does not pollute environment. Additionally, this is very durable (resistant) fluid—it can be used for more than six years or 350 000 km in the cooling system. It is used for temperatures between from −70° C. to +160, dependent on concentration (max. 96%). There should be noted that at low temperatures this fluid does not change to solid, but to frail, delicate crystals that do not make pressure to the wall of the engine, pipes and other parts, but break out those parts, and during engine ignition those crystals are readily heated and melted without damaging engine and other cooling system structures.

Following Table A shows different antifreeze composition variants, and therewith particular formulations will be dependent on climate and application conditions, and it is provided for use at temperatures from −15 to −70° C. and from +110 to +160° C.

TABLE A

FORMULATION

| | | | |
|---|---|---|---|
| A | B | C | D |

| | |
|---|---|
| Components in % | (additive content in the formulation) |

| | | | | |
|---|---|---|---|---|
| A) | | | | |
| Distilled water | 32.40 | 24.00 | 24.00 | 25.00 |
| Triethanolamine | 0.60 | 1.00 | 3.10 | 3.60 |
| Polycarboxylate | 0.60 | 1.00 | 2.60 | 3.40 |
| Benzotriazole | 0.50 | 1.50 | 3.20 | 4.80 |
| B) | | | | |
| Distilled water | 55.00 | 48.00 | 39.00 | 33.00 |
| Sodium tetraborate | 0.20 | 0.40 | 0.60 | 0.80 |
| Sodium nitrate | 0.20 | 0.30 | 0.40 | 0.45 |
| Sodium nitrite | 0.15 | 0.25 | 0.35 | 0.45 |
| Sodium sulphide | 0.10 | 0.25 | 1.10 | 1.40 |
| Potassium-sulphide | 0.13 | 0.90 | 2.20 | 2.90 |
| Sodium chromate | 0.10 | 0.20 | 0.65 | 1.00 |
| Sodium benzoate | 0.10 | 0.20 | 0.35 | 0.45 |
| Sodium hydroxide | 0.03 | 0.05 | 0.08 | 0.10 |
| C) | | | | |
| Distilled water | 10.00 | 20.00 | 19.00 | 20.00 |
| Sodium metaborate | 0.20 | 0.30 | 0.40 | 0.80 |
| Calcium cyanamide | 0.20 | 0.35 | 0.45 | 0.90 |

As already noted, specific agent composition will be depended on application conditions, agent in which it is used etc. Therefore for example for temperature of −25° C., additives from table “A”with 38% of basic substance (glycerol) are used, for temperature of −35° C. formulation from table “A”/B with 48% of basic substance is prepared, for temperature of −55° C. formulation from table “A”/C with 60% of basic substance is prepared and for temperatures above −65° C. formulation from table “A”/D i 88% of basic substance is prepared. All these combinations are resistant temperatures from +110 to +160° C.

Afterwards, product is packed according to market and manufacturer demands. This product can be used immediately.

Here follows description of composition of anti-corrosion non-toxic inhibitor water solution, i.e., description of regenerator composition for wasted antifreeze. This composition is inhibitor for above said antifreeze and as such it is ingredient of that antifreeze. At the same time, this inhibitor is designed for use as modifier and regenerator for wasted antifreeze, and it extends antifreeze lifetime and refreshes anti-corrosive protection of wide variety of internal combustion engines and also other engines, heating and cooling systems. This inhibitor is used in small concentrations for regeneration and modification of wasted antifreeze from 8%-12% by weight in which it is poured, i.e., antifreeze with 10%-18% of inhibitor.

Therefore, his invention provides aqueous concentrated anticorrosive formulation, which is suitable for use as additive for wasted fluid—antifreeze in engine cooling system. This invention enables extension of anti-corrosive protection lifetime for fluid/antifreeze in internal combustion engine cooling system. Referred to inhibitory properties, it has great ability for anti-corrosive protection This agent may be used as emulsifier and modifier.

It is very important that it is non-toxic inhibitor. Especially, advancement and effectiveness is represented by adding this inhibitor in small amounts to the wasted antifreeze, relative to total weight of wasted antifreeze. This inhibitor is very potent. It regenerates wasted antifreeze, it is resistant to high boiling temperature, it lowers freezing point, has great ability for heating and cooling system anti-corrosive protection, bring alkaline stocks to satisfactory level and rises pH value. Thereat, it can be used in any antifreeze, it is made of polycarboxylate, and it is soluble in alcohol, alcohol/water mixture and in water alone. It does not corrode, nor damages cooling system, and it is efficacious in a small concentration.

Namely, conventional fluids—antifreeze weaken due to application. Their lifetime is very limited. In drained antifreeze pH value lowers and its protection against corrosion becomes minimal or ceases.

Composition of anticorrosive agent—inhibitor water solution with particular additive type make, besides additives indicated for antifreeze composition, following additives:

1. Glycerol
chemical formula C₃H₈O₃
quality at least 98,0% (99,5%)

2. Water—soften or distilled

3. Benzotriazole who is an effective corrosion inhibitor of all variety of metals in neutral solutions.

4. Three-ethanol-amine (three-ethile-amine (HOCH₂CH₂)₃N a corrosion inhibitor of iron and steel in water solutions.

5. Sodium-tetraborate
chemical formula Na₂B₄O₇
an inhibitor in composition of this formulation of several meals, aluminum and its alloys.

6. Sodium-three-polyphosphate
applied for the protection of circular systems as heater exchanger from 4° C. till 99° C. It's efficient as the inhibitor in wide range of pH but not bellow 6. This additive isn't toxic.

7. Sodium-nitrate
chemical formula NaNO₃
in formula composition protects several metals

8. Sodium-nitrite
chemical formula NaNO₂
necessary concentration depends on conditions of corrosion and water composition in formulation.

9. Sodium-sulfide
chemical formula (without water Na₂SO₃) or (Na₂SO₃)7H₂O
in this formulation good corrosion inhibitor of magnesium, aluminum ad its alloys in alkali environment and in water solution of glycerol.

10. Potassium-sulfide
chemical formula K₂SO₄
quality at least 99%
solution—easily soluble in water
in this formulation inhibitor of aluminum, magnesium or its alloys.

11. Sodium-meta-silicate
inhibitor corrosion of aluminum in water solution of this formula

12. Potassium-dichromate
this additives is used for metal protection in contact with antifreeze.

13. Sodium-chromate
chemical formula in acids HNO3, H3PO4 i H2SO4
inhibitor of corrosion of steel, cast iron, aluminums copper, brass in water solution of this formulation

14. Sodium-benzoate
chemical formula C6H5SO6Na or (C7H5O2Na)
inhibitor of corrosion of steel in water solutions and well maintained pH values and alkalis

15. Benzolsulphamide
chemical formula C6H5SO2NH2
inhibitor of corrosion of black metals
in this formulation also of other metals and their alloys

16. Calcium-cyanamide
in this formulation inhibitor of corrosion of steel in water solutions and salt solutions

17. Sodium-hydroxide
suitable for aluminum protection as well as for maintain of alkali reserve and pH-value between 9-11

18. Polimark-polycarboxilate BASF, soluble in water and alcohol solution. In this invention marked as SOKALON® CP-12S or CP-10 In this formulation the ABC COBLEX's policarboxilate in concentration is also applicable.

19. Silicate oil

Therefore, for purpose of pH value maintenance between 9,5-11, silicates are used which are especially important for aluminum engines for protection of aluminum components in the cooling system, and also for maintenance of alkaline stocks in patent fluid. The most important component for pH value maintenance is sodium hydroxide with 0,5-10% by weight in solution.

Following table “B” shows different rants of anti-corrosive non-toxic inhibitor compositions and regenerator-modifier compositions for wasted antifreeze.

TABLE B

| | FORMULATION | | |
|---|---|---|---|
| Components (%) | A | B | C |
| A) | | | |
| Glycerol | 82.95 | 75.65 | 63.55 |
| Distilled water | 5.00 | 5.00 | 5.00 |
| Polimark-polycarboxylate | 1.0 | 1.30 | 1.60 |
| Benzotriazole | 1.0 | 2.20 | 4.20 |
| Triethanolamine | 0.80 | 1.10 | 1.60 |
| Sodium metasilicate | 0.20 | 0.40 | 0.90 |
| Potassium dichromate | 0.30 | 0.70 | 1.10 |
| B) | | | |
| Distilled water | 5.00 | 5.00 | 5.00 |
| Sodium tetraborate (borax) | 0.30 | 0.45 | 0.90 |
| Sodium nitrate | 0.35 | 0.40 | 0.70 |
| Sodium nitrite | 0.20 | 0.45 | 0.60 |
| Sodium sulphide | 0.30 | 0.90 | 2.20 |
| Potassium-sulphide | 0.25 | 0.40 | 1.20 |
| Sodium-tripolyphosphate | 0.20 | 0.60 | 0.75 |
| Sodium chromate | 0.20 | 0.45 | 1.20 |
| Sodium benzoate | 0.30 | 0.85 | 1.20 |
| Sodium hydroxide | 0.03 | 0.05 | 0.08 |
| C) | | | |
| Benzosulphamide | 0.30 | 0.45 | 1.00 |
| Calcium cyanamide | 0.45 | 1.10 | 1.20 |
| Silicate (silicate oil) | 0.005 | 0.005 | 0.005 |

Thus obtained regenerator is nontoxic.

There should be noted that for corrosion inhibition of all engine types, besides said inhibitors, monocarboxylic acids, and polycaroxylates in relatively small concentrations are suitable. Then, azole compounds, including mercaptobenzotriazole, benzotriazole salts, polytriazole salts are included. The preferred are nitrate salts nitrite salts, and mixture thereof. Then, phosphates way be used which are useful for corrosion inhibition, as is polycarboxylate.

Improved stable polycarboxylate type is based on polycrylic acid or polymaleic acid. These polycarboxylates are compatible with other components as in process for obtaining as in subsequent fluid utilization. Examples for polycarboxylates which can be used are those which are produced in German firm BASF under the trade name SOKALON. These are polycarboxylates which are available in water solutions. This inhibitor generally may be used in formulation from 0,01%-10%, but it is preferred from 0,01% to about 0,1% (by weight). This additive may be purchased under the trade name SOKALON® CP-12S or CP-10.

Process for obtaining is conducted in the reactor (container) by heating and cooling and keeping constant temperature between 80-90° C. Mixing process after the heating takes about 1 h. In this process 20-40% distilled (softened) water, 20-30% propylene glycol, 10-20% polyvalent alcohol (glycerol) measured and other inhibitor components. After that, follows cooling and packing according to market needs.

This regenerator for antifreeze is tested by modified method in 3×3 ASTM method and in DIN and by using DIN method. Additionally, standard test method for corrosion in engine coolant in glass vessel is used, with corrosive solution.

### BMF Review of Antifreeze and Regenerator for Wasted Antifreeze Tests

a) Antifreeze composition is tested and metal sample purification procedure is conducted according to modified ASTM specification.

At required temperature, 30-33% of corrosive water is used according to ASTM. All changes are weighted in mg, and they meet the standards.

TABLE 1

| | Allowed (ASTM) | Finding |
|---|---|---|
| Copper | 5 | −0.8 |
| Solder | 10 | +0.6 |
| Brass | 10 | −0.6 |
| Iron | 5 | +0.2 |
| Gray smelting | 5 | −2.4 |
| Aluminum | 10 | −5.0 |

Findings from ASTM tests from table 1 meet the standard.

b) Analogous corrosion tests

b1) Corrosion: coupons weight loss (the most mg)

TABLE 2

| | Allowed (ASTM) | Finding |
|---|---|---|
| Copper | 5 | −0.6 |
| Solder | 10 | +0.1 |
| Brass | 10 | −0.6 |
| Iron | 5 | +0.1 |
| Gray smelting | 5 | −2.3 |
| Aluminum | 10 | −5.9 |

Findings are obtained according to modified ASTM METHOD. Findings meet the standard.

b2) Corrosion: coupons weight loss, the most mg (JUS H.Z8.O56)

TABLE 3

| | Allowed (YUS) | Finding |
|---|---|---|
| Copper | 5 | +1.9 |
| Solder | 10 | +1.8 |
| Brass | 10 | +2.7 |
| Iron | 5 | +3.4 |
| Gray smelting | 5 | +3.7 |
| Aluminum | 10 | +4.0 |

Findings are obtained according to analogous method by JUS Hz8.O56 in glass vial with corrosive liquid 30%, and antifreeze 1:1 for temperature—18° C.

### Brief Review of Antifreeze and Regenerator Tests

Herein described antifreeze (i.e., anti-freezing and anti-corrosive agent) which is obtained by using regenerator for wasted antifreeze (with inhibitor), and regenerator alone, have been subjected to the following analyses:

1. Examination by University in Novi Sad, Faculty for technical science, laboratory for physical-technical and solar measurements in 1988 and 1989. Findings meet TUB, ASTM and DIN standards.

2. The extremely exploitation test has been performed for this antifreeze and regenerator, by metallic coupons processing trough their purification, and test was conducted according to modified ASTM method and specification. In such a way plates were installed in the cooling system of the General Motors engine: Pontiac 2.300 cc, Pontiac 3.100 cc, 1991 models, Chevrolet Corsica 3.100 KW and Beretta 2.300 cc, 1991 model. Coupons were used in exploitation test with vehicle driving during winter and summer period at external temperatures of −15° C. and between +35-40° C. Between 5.000 and 20.000 km were passed in these tests. Exploitation was tested with normal driving, as in common everyday car driving.

According to this examination results were obtained as in the table 4 (exploitation method).

TABLE 4

| | | | | Finding | Finding |
|---|---|---|---|---|---|
| | | Finding | Finding | Pontiac 2300 | Pontiac 3100 |
| | Allowed | Corsica | Beretta | cca | cca |
| Copper | 5 | −1.2 | −1.2 | +2.4 | +1.9 |
| Solder | 10 | −2.4 | −2.4 | −0.5 | +1.8 |
| Brass | 10 | −0.2 | −0.2 | +0.6 | +2.0 |
| Iron | 5 | +0.6 | +0.6 | +1.4 | +8.6 |
| Gray | 5 | +3.4 | +3.4 | +3.6 | +6.1 |
| smelting | | | | | |
| Aluminum | 10 | +3.7 | +3.7 | +6.1 | +3.6 |

Exploitation method: Corsica 3100 cc, passed 7.000 km; table 5, Beretta 2300 cc, passed 5.000 km; table 6, Pontiac 2300 cc, passed 10.000 km and table 7, Pontiac 3100 cc, passed 20.000 km. In all the vehicles coupons have been impelled for 8 months. Coupons were installed in the cooling system at the highest gravitation pressure. For example, water pump operating pressure was at an average about 1 kPa Average engine operating temperature was about +110° C. After coupons were removed, coupons were processed according to ASTM standard.

Findings indicate that this antifreeze is in accordance with high ASTM standard and it is satisfactory guarantee for all the engines in which it is used in their cooling systems, and not only in warranty period, but above 300.000 km and after 6 years of engine exploitation.

1. Non-toxic anti-freezing and anti-corrosion water solution comprising polyvalent alcohol such as glycerol from 38% to 88%, water and additives as inhibitors which is effective at temperatures from −65° C. to +110° C.

2. Non-toxic anti-freezing and anti-corrosion water solution according to claim 1, for temperatures up to −25° C., which is comprised of water solution of additives plus glycerol, where water solution of additives comprises 97.40% of distilled water, 0.60% of triethanolamine, 0.60% of polycarboxylate, 0.50% of benzotriazole, 0.20% of sodium tetraborate; 0.20% of sodium nitrate, 0.15% of sodium nitrite, 0.10% of sodium sulphide; 0.13% of potassium sulphide, 0.10% of Sodium chromate, 0.10% of Sodium benzoate, 0.03% of Sodium hydroxide, 0.20% of Sodium metaborate, 0.20% of calcium cyanamide, 0.005% of silicate oil, and where glycerol makes 38% of final non-toxic anti-freezing and anti-corrosion water solution.

3. Non-toxic anti-freezing and anti-corrosion water solution according to claim 1, for temperatures up to −35° C., which is comprised of water solution of additives plus glycerol, where water solution of additives comprises 92.0% of distilled water, 1.00% of triethanolamine, 1.00% of polycarboxylate, 1.50% of benzotriazole, 0.40% of sodium tetraborate, 0.30% of sodium nitrate, 0.25% of sodium nitrite, 0.25% of sodium sulphide, 0.90% of potassium sulphide, 0.20% of Sodium chromate, 0.20% of Sodium benzoate, 0.05% of Sodium hydroxide, 0.30% of Sodium metaborate, 0.35% of calcium cyanamide, 0.005% of silicate oil, and where glycerol makes 48% of final non-toxic anti-freezing and anti-corrosion water solution.

4. Nontoxic anti-freezing and anti-corrosion water solution according to claim , for temperatures up to −55° C., which is comprised of water solution of additives plus glycerol, where water solution of additives comprises 82.0% of distilled water, 3.10% of triethanolamine, 2.60% of polycarboxylate, 3.20% of benzotriazole, 0.60% of sodium tetraborate, 0.40% of sodium nitrate; 0.35% of sodium nitrite, 1.10% of sodium sulphide; 2.20% of potassium sulphide; 0.65% of Sodium chromate, 0.35% of Sodium benzoate 0.08% of Sodium hydroxide, 0.40% of Sodium metaborate, 0.45% of calcium cyanamide, 0.005% of silicate oil, and where glycerol makes 60% of final non-toxic anti-freezing and anti-corrosion water solution.

5. Non-toxic anti-freezing and anti-corrosion water solution according to claim 1, for temperatures up to 65° C., which is comprised of water solution of additives plus glycerol, where water solution of additives comprises 78.00% of distilled water, 3.60% of triethanolamine, 3.40% of polycarboxylate, 4.80% of beazotriazole, 0.80% of sodium tetraborate, 0.45% of sodium nitrate, 0.45% of sodium nitrite, 1.40% of sodium sulphide, 2.90% of potassium sulphide, 1.00% of Sodium chromate 0.45% of Sodium benzoate, 0.10% of Sodium hydroxide, 0.80% of Sodium metaborate, 0.90% of calcium cyanamide, 0.005% of silicate oil, and where glycerol makes 88% of final non-toxic anti-freezing and anti-corrosion water solution.

6. Regenerator for wasted antifreeze which comprises polyvalent alcohol such as glycerol water and additives as inhibitors.

7. Regenerator for wasted antifreeze, which comprises 82.95% of glycerol 10.00% of distilled water, 1.00% of polimark polycarboxylate, 1.00% of benzotriazole, 0.80% of triethanolamine, 0.20% of sodium metasilicate, 0.30% of potassium dichromate, 0.30% of sodium tetraborate (borax), 0.35% of sodium nitrate, 0.20% of sodium nitrite, 0.30% of sodium sulphide, 0.25% of potassium sulphide, 0.20% of sodium tripolyphosphate, 0.20% of sodium chromate, 0.30% of sodium benzoate, 0.03% of sodium hydroxide, 0.30% of benzosulphamide, 0.45% of calcium cyanamide and 0.005% of silicate (silicate oil).

8. Regenerator for wasted antifreeze, which comprises 75.65% of glycerol, 10.00% of distilled water, 1.30% of polimark polycarboxylate 2.20% of benzotriazole, 1.10% of triethanolamine, 0.40% of sodium metasilicate, 0.70% of potassium dichromate, 0.45% of sodium tetraborate (borax), 0.40% of sodium nitrate, 0.45% of sodium nitrite, 0.90% of sodium sulphide, 0.40% of potassium sulphide, 0.60% of sodium tripolpyhosphate, 0.45% of sodium chromate, 0.85% of sodium benzoate, 0.05% of sodium hydroxide, 0.45% of benzosulphamide, 1.10% of calcium cyanamide and 0.005% of silicate (silicate oil).

9. Regenerator for wasted antifreeze, which comprises 63.55% of glycerol 10.00% of distilled water, 1.60% of polimark polycarboxylate, 4.20% of benzotriazole 1.60% of triethanolamine, 0.90% of sodium metasilicate, 1.10% of potassium dichromate, 0.90% of sodium tetraborate (borax), 0.70% of sodium nitrate, 0.60% of sodium nitrite, 2.20% of sodium sulphide, 1.20% of potassium sulphide, 0.75% of sodium tripolyphosphate, 1.20% of sodium chromate, 1.20% of sodium benzoate, 0.08% of sodium hydroxide, 1.00% of benzosulphamide, 1.20% of calcium cyanamide and 0.005% of silicate (silicate oil).
